(19) United States
(12) Patent Application Publication
(10) Pub. No.: US 2010/0061796 A1
(43) Pub. Date: Mar. 11, 2010

(54) Rotatable connection adapter

(75) Inventor: Christof Kurth, Bayreuth (DE)

Correspondence Address: PYLE & PIONTEK, LLC, 221 N LASALLE STREET , ROOM 1207, CHICAGO, IL, 60601, US

(73) Assignee: Medi GmbH & Co., KG, Bayreuth (DE)

(21) Appl. No.: 12/311,004

(22) PCT Filed: Sep. 20, 2007
(86) PCT No.: PCT/DE2007/001691

§ 371 Date: Mar. 16, 2009

(30) Foreign Application Priority Data
Sep. 22, 2006 (DE) 20 2006 014 753.5

(51) Int. Cl. F16C 11/00; F16B 9/00

(52) U.S. Cl. 403/66; 403/196

(57) ABSTRACT

Rotatable connection adapter particularly as prosthetic fitting part with integrated rotation adjustability for artificial limbs such as prostheses, comprising at least one attachment part and a connection part, wherein a further prosthetic fitting part is joined to the connection adapter in such a way that it can be rotated relative to the attachment part but can also be fixed in a defined position, wherein the attachment part has an axial through-bore and, on the underside, an additional coaxial recessed bore of blind bore of greater diameter into which a connection element engages which, at one end, has an at least partially circumferential non-self-clamping edge of smaller height than the depth of the recessed bore or blind bore and which has a diameter smaller than the recessed bore or the blind bore but greater than the through-bore through the attachment part, wherein the connection element, on the side opposite the circumferential edge, has an axially oriented clamping device which acts between the connection part and the further prosthetic fitting part for fixing the connection adapter on a further prosthetic fitting part and which clamping device under tension also suppresses the rotatability between the connection adapter and a further prosthetic fitting part.

The present invention relates to a rotatable connection adapter, in particular as a prosthetic fitting part with integrated rotation adjustability for artificial limbs such as prostheses, consisting of at least one attachment part and one connection part, wherein a further prosthetic fitting part is joined to the connection adapter in such a way that is rotatable with respect to the attachment part but can also be fixed in a defined position.

Various variations of adapters for assembly of prosthetic fitting parts are known. Some of these adapters are pure fixing adapters and others are adjustable through rotation and adaptable to the application required or can be adjusted to the needs of the person wearing it.

The document GB 86 20 674.5 U1 proposes e.g., a pure connection adapter which however cannot be rotated.

Adapters of the type mentioned, which comprise on the one side a clamping device guided in a mount such as a pyramid head and which are screwed or clamped together once the two prosthetic parts have been aligned, are also known.

On these systems, a relative setting or rotation of the two prosthetic fitting parts is released by unscrewing the screws by means of which the lower part, which is not provided with the clamping device, is screwed or firmly pressed on the prosthetic stump e.g., and the desired orientation is set.

A disadvantage hereby is that all the screws on the attachment part must always be opened so that the connection must in most cases be fit anew as a result thereof, even in case of only a small change in the axial orientation of the attachment parts.

For this purpose, an orthopaedic technician must take the entire prosthesis in his shop to adjust it anew.

It is the object of the present invention to provide a rotatable adapter which circumvents the known disadvantages and which allows for simple adjustment or change in the adjustment.

This object is achieved with the features of the characterizing portion of claim 1. Developed implementations and advantageous embodiments of the invention are included in the other claims.

In accordance with the invention, there is provided a rotatable connection adapter, in particular as a prosthetic fitting part with integrated rotation adjustability for artificial limbs such as prostheses, consisting of at least one attachment part and one connection part, wherein a further prosthetic fitting part is joined to the connection adapter in such a way that it is rotatable with respect to the attachment part but can also be fixed in a defined position, wherein the attachment part has an axial through-bore and, on the underside, an additional coaxial recessed bore or blind bore of greater diameter into which a connection element engages which, at one end, has an at least partially circumferential non-self-clamping edge of smaller height than the depth of the recessed bore or the blind bore and which has a diameter smaller than the recessed bore or the blind bore but greater than the through-bore through the attachment part, wherein the connection element, on the side opposite the circumferential edge, has an axially oriented clamping device which acts between the connection part and the further prosthetic fitting part for fixing the connection adapter on a further prosthetic fitting part and which clamping device under tension also suppresses the rotatability between the connection adapter and a further prosthetic fitting part.

According to a preferred implementation, the connection piece is provided with a pyramidal head with four faces on the side opposite the circumferential, non-self-clamping edge, the apex of the pyramid pointing in the direction of the circumferential edge and the base of the pyramid forming the end of said connection piece.

Implementations of the invention, which are also preferred, are, depending on the case and kind of utilization of the prosthetic fitting parts to be joined together, the implementation as a solid or a hollow cylinder with lateral engagement portions or bores, as a spherical head or as a calotte on the side opposite the circumferential edge, for the connection piece. On the implementations with a pyramidal head, a spherical head or a calotte, one obtains on the connection piece, on the side opposite the circumferential edge, surfaces such as the four side faces of a pyramidal head having four faces.

Using a solid or a hollow cylinder as the connection piece, the connection piece comprises, on the side located opposite the circumferential edge, a cylinder having side bores, at need threaded bores, made in the cylinder wall. Another prosthetic fitting part, which is to be mounted or fixed to the connection piece, also comprises bores on its circumference, which is preferably also cylindrical, said bores having to be brought into engagement with the bores in the connection piece.

According to a preferred implementation of the invention, the connection adapter, or the connection adapter system, is implemented with four screws on the described clamping device, which, through tightening, allow for a rigid connection between the connection piece and the prosthetic fitting part by clamping the circumferential edge of the connection piece against the recessed bore or the blind bore in the attachment part.

With the clamping screws, which are configured so as to be slightly inclined with respect to the axis connecting the two prosthetic fitting parts, a force is generated, which acts upon the connection piece and upon the other prosthetic fitting part and which pulls the connection piece along the through-bore in the attachment part in the direction of the further prosthetic part.

Through this tensile force, which is generated by clamping, the circumferential edge of the connection piece is pressed against the circumference of the recessed bore or of the blind bore in the attachment part, so that clamping occurs there.

The clamping between the circumferential edge of the connection piece and the circumference of the recessed bore or of the blind bore in the attachment part, which is caused by the clamping screw connections between the connection piece and the further prosthetic fitting part, generate a rigid connection of the fitting parts and prevent relative rotation thereof, ideally up to a torque of at least 50 Nm, which acts thereupon.

According to a desirable implementation, this mentioned, preferred clamping connection is not self-clamping; instead, it allows rotatability of the two parts as soon as the clamping connection on the opposite side between the connection piece and the further prosthetic fitting part has been loosened. In a preferred implementation, it is sufficient if only two of the preferably four screws arranged are being loosened on the clamping connection between the connection piece and the further prosthetic fitting part in order to allow again rotatability between the attachment part and the connection piece.

The possibility to allow rotatability of the prosthetic fitting parts joined together with the rotatable connection adapter by loosening only two clamping screws, allows for very simply changing and adapting the positions of the prosthetic fitting parts with respect to each other in order e.g., to optimize the walking pattern of a prosthesis wearer or to better adapt it to his or her needs.

The screws for generating the clamping connection mentioned, which have been used and described, are preferably configured to be stud screws.

In the preferred implementation of the invention, the surface of the circumferential edge on the side turned toward the attachment part and/or the circumference of the recessed bore or of the blind bore in the attachment part are configured to have a toothed surface feature, a knurling, a detent pattern or a raised scallop height. On the one side, this increases the clamping force building up there when clamping is activated between the attachment part and the connection piece and on the other side, it allows for very precise, reproducible changes in the relative rotation between the prosthetic fitting parts, which facilitates to the user the manipulation and adjustment of this adapter.

The invention will be described in closer detail herein after by way of example. In the drawings:

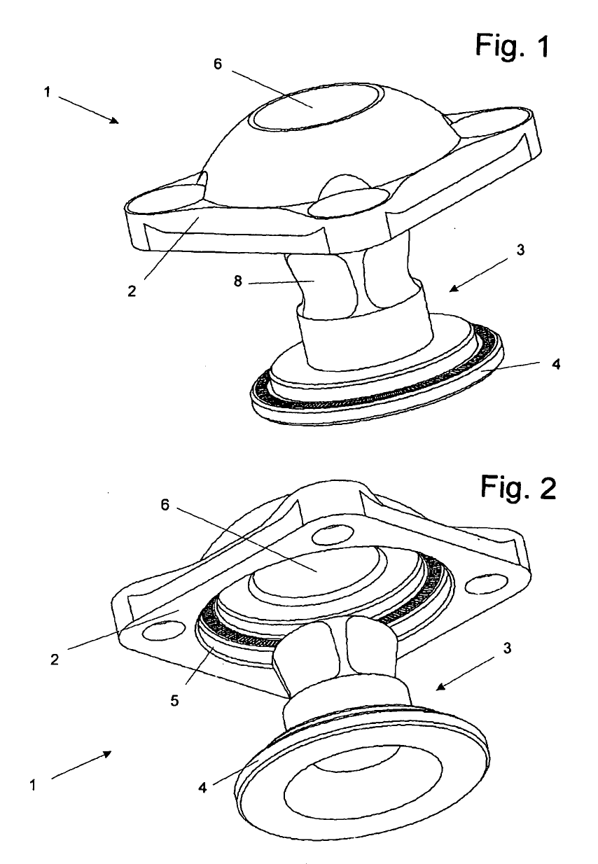

FIG. 1 shows a first implementation of a connection adapter.

FIG. 2 shows another view of the connection adapter shown in FIG. 1.

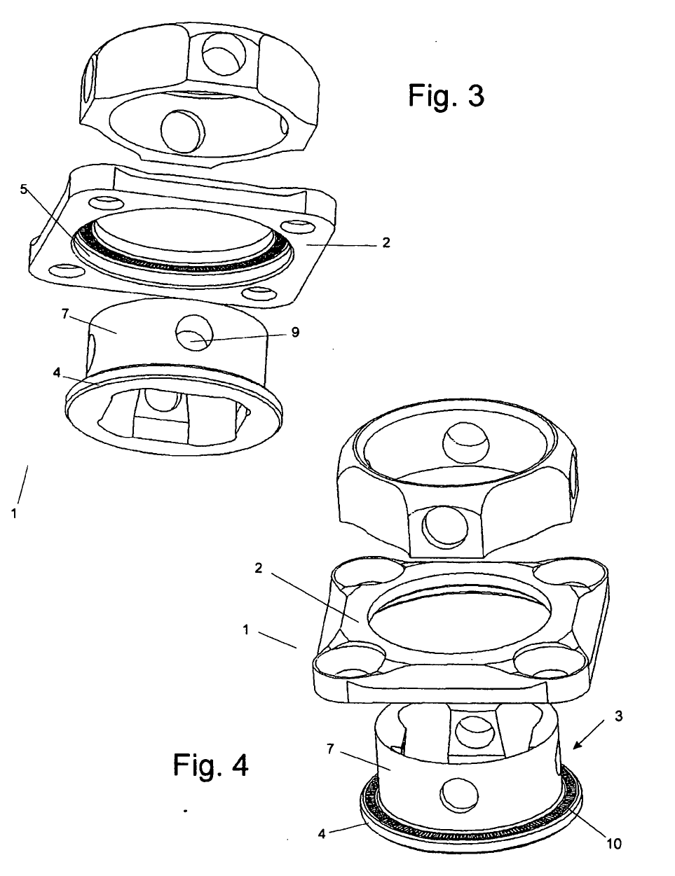

FIG. 3 shows another implementation of a connection adapter.

FIG. 4 shows another view of the connection adapter shown in FIG. 3.

The connection adapter 1 in the implementation shown in FIG. 1 and in FIG. 2 consists of the connection piece 3 and of the attachment part 2. In the implementation shown herein, the attachment part comprises on its upper side a curved surface for a prosthetic fitting part to rest for attachment, which comprises a seat for receiving the pyramidal head with its faces 8 of the connection piece 3.

When bracing the pyramidal head in the further prosthetic fitting part by screwing and clamping it on the pyramid faces 8, the connection piece 3 is pulled upward by the axial through-bore 6 and the circumferential cylindrical edge 4 is pulled with its surface against the groove in the coaxial blind bore 5 of the attachment part, so that the two parts are braced together and that they are prevented from rotating with respect to each other.

In FIG. 3 and in FIG. 4, there is shown a variant having a connection piece 7 configured to be a hollow cylinder for connection with such a further prosthetic fitting part. Here also, the clamping connection between the connection piece 7 and the attachment part 2 occurs by pulling the edge 4 of the connection piece 7 against the groove of the blind bore 5, the two parts being clamped against each other and being prevented from rotating with respect to each other. Through the detent pattern 10 made therein, a reproducible, precise adjustment of the angle about which the two parts are caused to rotate with respect to each other is facilitated.

Having described preferred implementations of the invention with reference to the appended drawings, it is noted that the invention is not limited to these precise implementations and that it will be understood by a person of ordinary skill in the art that various changes and modifications can be made to the present invention without departing from the spirit and scope of the invention as it is defined by the appended claims.

1. A rotatable connection adapter (1), in particular as a prosthetic fitting part with integrated rotation adjustability for artificial limbs such as prostheses, consisting of at least one attachment part (2) and one connection part (3), wherein a further prosthetic fitting part is joined to said connection adapter (1) in such a way that it is rotatable with respect to said attachment part (2) but can also be fixed in a defined position, characterized in
that said attachment part (2) has an axial through-bore (6) and, on the underside, an additional coaxial recessed bore or blind bore (5) of greater diameter into which a connection element (3) engages which, at one end, has an at least partially circumferential non-self-clamping edge (4) of smaller height than the depth of the recessed bore or the blind bore (5) and which has a diameter smaller than the recessed bore or the blind bore but greater than the through-bore (6) through the attachment part (2), wherein the connection element (3), on the side opposite the circumferential edge, has an axially oriented clamping device which acts between said connection part (3) and said further prosthetic fitting part for fixing said connection adapter (1) on a further prosthetic fitting part and which clamping device under tension also suppresses the rotatability between said connection adapter (1) and a further prosthetic fitting part.

2. The rotatable connection adapter as set forth in claim 1, characterized in
that the connection piece (3) is configured to be a pyramidal head (8) with four faces on the side opposite the circumferential edge (4).

3. The rotatable connection adapter as set forth in claim 1, characterized in
that the connection piece (3) is configured to be a solid or a hollow cylinder (7) on the side opposite the circumferential edge (4) and is provided with lateral engagement portions or bores (9).

4. The rotatable connection adapter as set forth in claim 1, characterized in
that the connection piece (3) is configured to be a spherical head or a calotte on the side opposite the circumferential edge (4).

5. The rotatable connection adapter as set forth in claim 1, characterized in
that the connection piece (3) comprises, on the side opposite the circumferential edge (4), surfaces (8) for bracing screws of a further prosthetic fitting part.

6. The rotatable connection adapter as set forth in claim 1, characterized in
that the connection piece (3) comprises, on the side opposite the circumferential edge (4), a clamping device with screws for fixed connection of a prosthetic fitting part to said connection adapter (1).

7. A clamping device as set forth in claim 6, characterized in
that the clamping device comprises four screws by means of which another prosthetic fitting part, which comprises a pyramidal head with four faces located on a spherical calotte, is rigidly connected to the rotatable connection adapter by tightening the screws.

8. The clamping device as set forth in claim 6, characterized in
that the clamped screw connection is configured to be inclined with respect to the axis connecting the two prosthetic fitting parts (1, 2).

9. The clamping device as set forth in claim 6, characterized in
that the active clamped screw connection comprises a rigid non-rotatable connection of the two prosthetic fitting parts up to an axially acting torque of 50 Nm.

10. The clamping device as set forth in claim 6, characterized in
that the screws for the clamped screw connection are stud screws.

11. A rotatable connection adapter as set forth in claim 1, characterized in
that the circumferential groove and/or the underplate of the connection part (3), which forms in the blind bore, is configured to have a toothed surface feature, a knurling, a detent pattern or a raised scallop height (10).

12. A rotatable connection adapter as set forth in claim 11, characterized in
that, by virtue of the toothed surface feature, the knurling or the detent pattern (10) it is possible to perform a defined and reproducible change in the angle of rotation.
